(19) United States
(12) Patent Application Publication
(10) Pub. No.: US 2024/0330962 A1
(43) Pub. Date: Oct. 3, 2024

(54) INFORMATION PROCESSING APPARATUS AND INFORMATION PROCESSING METHOD

(71) Applicant: Toshiba Tec Kabushiki Kaisha, Tokyo (JP)

(72) Inventor: Katsuhito MOCHIZUKI, Izunokuni Shizuoka (JP)

(21) Appl. No.: 18/410,460

(22) Filed: Jan. 11, 2024

(30) Foreign Application Priority Data
Apr. 3, 2023 (JP) 2023-060242

(51) Int. Cl. G06Q 30/018

(52) U.S. Cl. CPC G06Q 30/0185

(57) ABSTRACT

According to an embodiment, an information processing apparatus acquires a detection result of a sensor that detects an increase or a decrease in number of commodities put in a cart. The information processing apparatus acquires commodity registration managing information. The information processing apparatus determines a fraudulent operation on the basis of the detection result and the commodity registration managing information. Further, the information processing apparatus calculates fraudulent points on the basis of a result of the determination.

### CROSS-REFERENCE TO RELATED APPLICATIONS

This application is based upon and claims the benefit of priority from the prior Japanese Patent Application No. 2023-60242, filed on Apr. 3, 2023, the entire contents of which are incorporated herein by reference.

### FIELD

Embodiments described herein generally relate to an information processing apparatus and an information processing method.

### BACKGROUND

In recent years, a cart POS system in which a point-of-sales (POS) apparatus is mounted on a shopping cart or a smartphone POS has been prevailing. In such a POS system, a customer performs commodity registration of a commodity to be purchased by him/herself, and puts the commodity in the shopping cart. Therefore, there is a possibility that a commodity bar code of the commodity to be put in the shopping cart is forgotten to be read, or the commodity is forgotten to be returned to a shelf when the registration thereof is cancelled, for example.

There are known techniques for detecting a fraud such as forgetting to read a commodity bar code or forgetting to return a commodity to a shelf when registration is cancelled. In the related art, a fraud may be erroneously detected, and unnecessary notifications may be presented to a customer, thus causing discomfort. In this regard, there is a need for a technique for reducing the number of notifications due to erroneous detection of a fraud.

### BRIEF DESCRIPTION OF THE DRAWINGS

FIG. 1 is a block diagram illustrating an information processing system according to an embodiment.

FIG. 2 is a sequence diagram illustrating information processing by the information processing system according to the embodiment.

FIG. 3 is a schematic diagram showing an example of a notification image displayed in a point-of-sales (POS) terminal according to the embodiment.

FIG. 4 is a schematic diagram showing an example of a notification image displayed in an attendant terminal according to the embodiment.

FIG. 5 is a flowchart showing an example of information processing by the POS terminal according to the embodiment.

### DETAILED DESCRIPTION

According to one embodiment, an information processing apparatus receives, when a user puts a commodity to be purchased in a cart in which and from which a commodity can be put and taken out, a user operation for registration processing of the commodity to be purchased and performs the registration processing of the commodity to be purchased. The information processing apparatus includes a communication interface, a storage device, a memory, and a processor. The communication interface receives a detection result of a sensor included in the cart. The sensor detects an increase or a decrease in number of commodities put in the cart. The storage device stores the detection result of the sensor and commodity registration managing information including commodity information based on the registration processing of the commodity to be purchased. The memory stores a program for executing an operation of the information processing apparatus. The processor executes the program to acquire the detection result of the sensor via the communication interface and causes the storage device to store the detection result. Further, the processor acquires the commodity registration managing information and causes the storage device to store the commodity registration managing information each time the registration processing of the commodity to be purchased is performed. Further, the processor determines a user's fraudulent operation regarding putting a commodity in and taking a commodity out of the cart on the basis of the detection result and the commodity registration managing information. Further, the processor calculates fraudulent points on the basis of a result of the determination.

### Configuration Example

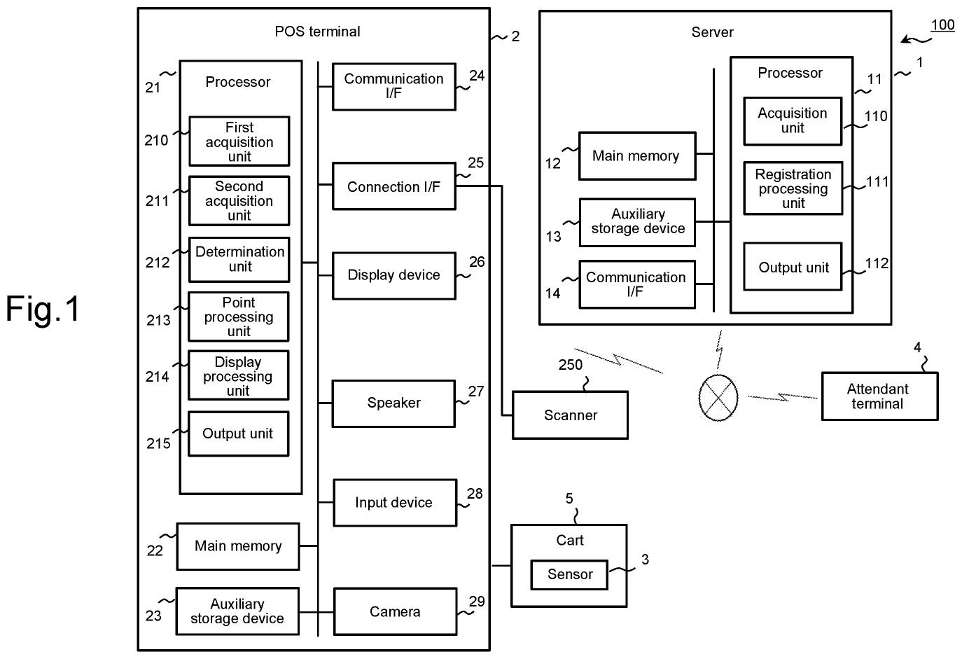

Hereinafter, an embodiment will be described with reference to the drawings. In the drawings, the same constituent elements will be denoted by the same reference symbol as much as possible, and overlapping description will be omitted. FIG. 1 is a block diagram illustrating an information processing system 100 according to the embodiment. The information processing system 100 includes a server 1, a point-of-sales (POS) terminal 2, an attendant terminal 4, and a cart 5. The cart 5 includes a sensor 3. The server 1, the POS terminal 2, and the attendant terminal 4 are communicably connected to each other via a network. For example, the network includes one or more networks of various networks such as the Internet, a portable communication network, and a local area network (LAN). The one or more networks may include a wireless network or a wired network. Note that the information processing system 100 means a system including at least two devices of the server 1, the POS terminal 2, and the attendant terminal 4 in some cases.

The server 1 is an electronic device that collects data and processes the collected data. The electronic device includes a computer. The server 1 connects the POS terminal 2 and the attendant terminal 4 to each other communicably via the network. The server 1 receives various types of data from the POS terminal 2 and the attendant terminal 4 and outputs various types of data to the POS terminal 2 and the attendant terminal 4. A configuration example of the server 1 will be described later.

The POS terminal 2 is an electronic device that is communicable with another electronic device. The POS terminal 2 is, for example, a device that is used by a customer shopping in a store. The POS terminal 2 is a device that can receive a commodity registering operation such as a change in the quantity of registered commodities to be purchased or a cancel thereof. Specifically, the POS terminal 2 receives a customer's operation for registering a commodity to perform registration processing of a commodity to be purchased. The registration processing of a commodity to be purchased includes acquisition of identification information of the commodity to be purchased and acquisition of the quantity of (number of) commodities to be purchased. Further, the registration processing of a commodity to be purchased includes a registration change such as cancel of a commodity to be purchased or change in the quantity of commodities to be purchased. The customer performs, for example, an operation of causing a camera incorporated in the POS terminal 2 or externally connected thereto or a scanner to read a commodity bar code attached to the commodity. The POS terminal 2 acquires commodity identification information (identification code or the like of commodity) from the read commodity bar code. The customer operates an input device of the POS terminal 2 to perform input for cancelling a registered commodity to be purchased or changing the quantity of registered commodities to be purchased, for example. With this input operation, the POS terminal 2 changes the registration of the commodities to be purchased. Note that, in this embodiment, the customer is assumed to put the registered commodities to be purchased in the cart 5. In this sense, the registered commodity to be purchased is a commodity put in the cart 5. Further, the quantity of registered commodities to be purchased is the quantity of commodities put in the cart 5. The POS terminal 2 may be a terminal mounted on the cart 5 to be used or may be a terminal used without being mounted on the cart 5. The POS terminal 2 may be a terminal rented in the store or may be a terminal owned by the user. The POS terminal 2 is a personal computer (PC), a smartphone, a tablet terminal, or the like. In the following description, the customer may be regarded as a user. The POS terminal 2 is an example of an information processing apparatus. A configuration example of the POS terminal 2 will be described later. The customer is an example of a user of the POS terminal 2. A plurality of POS terminals 2 may be provided in one store.

The sensor 3 is an electronic device that is mounted on the cart 5 and communicable with another electronic device. The sensor 3 is, for example, a weighing device that detects the weight of a commodity put in the cart 5. In this case, the sensor 3 acquires weighing information indicating a time-series increase or decrease in the value of the weight of the cart 5. The value of the weight is, for example, a median value of a plurality of values indicated by the weighing information at a plurality of consecutive timings. Note that the value of the quantity based on the weighing information may be a mean value or a mode value other than the median value and is not limited thereto. The sensor 3 may determine an increase or decrease in the quantity in the cart 5 on the basis of a threshold set in advance. For example, a case where a threshold for determining an increase is “+25 grams” and a threshold for determining a decrease is “−25 grams” will be described. If a positive value is equal to or larger than 25 grams, the sensor 3 may determine an increase in quantity. If a negative value is equal to or larger than 25 grams, the sensor 3 may determine a decrease in quantity. The sensor 3 determines whether or not a suitable operation corresponding to a detection result of variations in quantity in the cart 5 has been performed by the user. The sensor 3 outputs a detection result indicating that the quantity of commodities in the cart 5 has varied or the quantity has not varied on the basis of the weighing information to the POS terminal 2 at predetermined time intervals. The sensor 3 may be a camera that captures images of the commodities put in the cart 5. In this case, the sensor 3 detects an increase or decrease in the quantity of commodities put in the cart 5 on the basis of the images of the commodities. The sensor 3 outputs a detection result regarding the increase or decrease in the quantity of commodities to the POS terminal 2 at predetermined time intervals. The predetermined time intervals include 200-millisecond intervals, 100-millisecond intervals, and the like. The detection result may indicate, for example, no variations in quantity, an increase in quantity, and a decrease in quantity. The detection result may include, for example, a value of an increase or decrease, such as “+30 grams”.

If the cart has an upper stage and a lower stage, the sensor 3 may detect an increase or decrease in the quantity of commodities put on the upper stage and that on the lower stage at the same time. The cart 5 is, for example, a shopping cart used by the customer in the store. The sensor 3 may include a motion sensor for increasing weighing accuracy. The motion sensor may detect stop and movement of the cart 5.

The attendant terminal 4 is an electronic device that is communicable with another electronic device. The attendant terminal 4 is, for example, a device used by an attendant who monitors and supports the behavior of a customer in the store. For example, the attendant terminal 4 is a PC, a smartphone, a tablet terminal, or the like. The attendant may be regarded as a store clerk, staff, a user, or a person. The attendant is an example of the user of the attendant terminal 4. A plurality of attendant terminals 4 may be provided in one store.

A configuration example of the server 1 will be described. As shown in FIG. 1, the server 1 is an electronic device including a processor 11, a main memory 12, an auxiliary storage device 13, and a communication interface 14. The units constituting the server 1 are connected to each other so as to be capable of inputting and outputting signals. In FIG. 1, the interface is described as “I/F”.

The processor 11 corresponds to the central portion of the server 1. The processor 11 is an element constituting the computer of the server 1. For example, the processor 11 is a central processing unit (CPU), but is not limited thereto. The processor 11 may include various circuits. The processor 11 loads a program stored in advance in the main memory 12 or the auxiliary storage device 13 to the main memory 12. The program is a program that causes the processor 11 of the server 1 to implement or execute the units to be described later. The processor 11 executes the program loaded to the main memory 12 to execute various operations.

The main memory 12 corresponds to a main storage portion of the server 1. The main memory 12 is an element constituting the computer of the server 1. The main memory 12 includes a nonvolatile memory area and a volatile memory area. The main memory 12 stores the operating system or a program in the nonvolatile memory area. The volatile memory area of the main memory 12 is used as a work area in which data is appropriately rewritten by the processor 11. For example, the main memory 12 includes a read only memory (ROM) as the nonvolatile memory area. For example, the main memory 12 includes a random access memory (RAM) as the volatile memory area. The main memory 12 stores the program.

The auxiliary storage device 13 corresponds to an auxiliary storage portion of the server 1. The auxiliary storage device 13 is an element constituting the computer of the server 1. The auxiliary storage device 13 is an electric erasable programmable read-only memory (EEPROM) (registered trademark), a hard disc drive (HDD), a solid state drive (SSD), or the like. The auxiliary storage device 13 stores the program described above, data used by the processor 11 to perform various types of processing, and data created in the processing by the processor 11. The auxiliary storage device 13 stores the program described above.

The auxiliary storage device 13 stores commodity registration managing information for one or more POS terminals 2. The commodity registration managing information is information based on transaction processing in each POS terminal 2. The commodity registration managing information includes a store code, a terminal code, a transaction code, a transaction status, and information on details of transaction. The transaction code is unique identification information assigned to each transaction. The transaction status indicates a state of a transaction. The state of a transaction includes, for example, “entry to store”, “during shopping”, “during checkout”, and “leaving from store”. “Entry to store” indicates a state from the start of use until first registration processing of a commodity to be purchased. “During shopping” indicates a state in which the registration processing of a commodity to be purchased is being performed for the transaction of the POS terminal 2. “During checkout” indicates a state in which payment processing is being performed for the transaction of the POS terminal 2. “Leaving from store” indicates a state in which the transaction processing such as the registration processing, the payment processing, or the like of the commodity to be purchased has been finished for the transaction of the POS terminal 2. The information on details of transaction includes commodity information of a registered commodity, information of payment processing, and the like. The commodity information of a commodity (hereinafter, simply referred to as commodity information in some cases) includes a commodity name, a price, and the like stored in a commodity master, which will be described later, in association with the commodity identification information. The commodity information of a registered commodity includes the commodity identification information, the quantity of commodities, the money amount of commodities, and the like. The commodity identification information is unique identification information assigned to each commodity to identify the individual commodities and is, for example, an identification code. The information on details of transaction can be updated on the basis of a user operation on the POS terminal 2. The user operation includes the commodity registering operation. The commodity registering operation includes operations of registering a commodity to be purchased, changing the quantity of registered commodities to be purchased, cancelling the registered commodities to be purchased, and the like as described above. Specifically, the commodity registering operation includes a plus operation and a minus operation. The plus operation includes an operation of registering a commodity to be purchased and an operation of increasing the quantity of commodities to be purchased. The minus operation includes an operation of cancelling a commodity to be purchased and an operation of decreasing the quantity of commodities to be purchased. More specifically, the operation of registering a commodity to be purchased is, for example, an operation by a user passing a scanner 250 (see FIG. 1) over a commodity to be purchased in order to read the commodity identification information of the commodity to be purchased. The plus operation and the minus operation are, for example, user operations performed on the input device 28 (see FIG. 1). The information of the payment processing is detailed information regarding the payment processing. The commodity registration managing information may include time information indicating a date and time at which the commodity registration managing information is updated. The commodity registration managing information includes an accumulated value of fraudulent points to be described later. The accumulated value of fraudulent points is, for example, an accumulated value in a certain period of time. The accumulated value of fraudulent points is also referred to as accumulated point value. The certain period of time may be, for example, 30 minutes or one hour. The certain period of time may be, for example, a period of time from the start of shopping to the start of checkout.

The auxiliary storage device 13 stores a detection result by the sensor 3 for one or more POS terminals 2. The detection result includes quantity increase/decrease information indicating an increase or decrease the quantity of commodities put in the cart 5, which is detected by the sensor 3. The quantity increase/decrease information includes information such as an increase in quantity, a decrease in quantity, and no variations in quantity. The number of commodities put in the cart 5 is also referred to as the quantity of commodities in the cart. The detection result is data output from the sensor 3 in chronological order. The detection result may include time information indicating a date and time at which the detection result is detected. The auxiliary storage device 13 can hold the detection result for a certain period of time. The auxiliary storage device 13 can delete the detection result after the holding period of time elapses.

The auxiliary storage device 13 stores fraudulent point information. The auxiliary storage device 13 may store fraudulent point information for each store. The fraudulent point information indicates information for calculating fraudulent points. The fraudulent point information indicates, for example, a point value given to a fraudulent operation. The fraudulent operation includes an operation that does not correspond to variations in increase or decrease in quantity of commodities in the cart. For example, the fraudulent operation includes a cancel operation, a minus operation of the quantity, no operation, and the like for an increase in quantity of commodities in the cart. In this case, it is conceivable that the user has forgotten an operation of registering a commodity, has performed a cancel operation by mistake, or has performed a minus operation of the quantity by mistake, with a commodity being put in the cart. The fraudulent operation includes a registration operation, a plus operation of the quantity, no operation, and the like for a decrease in quantity of commodities in the cart. In this case, it is conceivable that the user has forgotten an operation of cancelling the commodity, has performed a registration operation by mistake, or has performed a plus operation of the quantity by mistake, with a commodity being taken out of the cart. The fraudulent operation includes a registration operation, a plus operation of the quantity, a cancel operation, a minus operation of the quantity, and the like for the case of no variations in quantity of commodities in the cart. In this case, it is conceivable that the user has performed an operation of cancelling a commodity by mistake, has performed a registration operation by mistake, has performed a plus operation of the quantity by mistake, or has performed a minus operation of the quantity by mistake, in a state in which the user does not take a commodity in and out of the cart.

The point value can be set in accordance with the type of the fraudulent operation. For example, if the number of is larger than the quantity registered commodities of commodities in the cart, the point value may be set to be high. If the number of registered commodities is smaller than the quantity of commodities in the cart, the point value may be set to be low. The point value can be set in accordance with the level of the fraudulent operation. For example, the number of times of fraudulent operations exceeds a predetermined number, the point value may be set to be high. For example, the number of times of fraudulent operations exceeds five, fraudulent points may be added. The point value can be set on the basis of a difference between a timing at which an increase or decrease in quantity of commodities in the cart is detected and a timing of a user operation. The timing at which an increase or decrease in quantity of commodities in the cart is detected corresponds to a date and time at which the detection result is detected. The timing of the user operation corresponds to a date and time at which the commodity registration managing information is updated. For example, if the difference between the timing at which an increase or decrease in quantity of commodities in the cart is detected and the timing of a user operation is large, the point value may be set to be high. If the difference between the timing at which an increase or decrease in quantity of commodities in the cart is detected and the timing of a user operation is small, the point value may be set to be low. The point value can be set in accordance with the type of commodities. For example, if a decrease in quantity of commodities in the cart or no variations in quantity is detected and if a user operation of cancelling an expensive commodity or a commodity that needs intervention of a store clerk, such as alcohol, is performed, the point value may be set to be high. The point value can be set in accordance with the quantity of commodities. For example, if a decrease in quantity of commodities in the cart or no variations in quantity is detected and if a user operation of cancelling a plurality of commodities is performed, the point value may be set to be high. The point value may be set in advance or may be appropriately updated by a store clerk or the like.

If the sensor 3 is a weight sensor, an increase or decrease in the number of commodities may be detected due to a large shake of the cart. In this case, if a fraudulent operation is detected after a large shake of the cart, it is highly likely to be an increase in the number of commodities due to a shake of the cart, and thus the point value may be set to be low. On the other hand, if a fraudulent operation is detected without shake of the cart, the point value may be set to be low.

If the sensor 3 is a camera, an increase or decrease in the number of commodities may be detected due to overlapping commodities. In this case, if an increase or decrease in the number of commodities is detected at close timings a plurality of times, the point value may be set to be low.

If the sensor 3 is a camera, and when it is detected that an expensive commodity such as alcohol is put in the cart, a point value provided when a fraudulent operation is detected may be set to be high.

The communication interface 14 includes various interfaces that communicably connect the server 1 and another electronic device to each other according to a predetermined communication protocol via a network.

Note that a hardware configuration of the server 1 is not limited to the configuration described above. The server 1 can appropriately omit and change the constituent elements described above and add a new constituent element.

The units implemented by the processor 11 described above will be described. The processor 11 implements an acquisition unit 110, a registration processing unit 111, and an output unit 112. The units implemented by the processor 11 can also be referred to as functions. The units implemented by the processor 11 can also be described as being implemented by a controller including the processor 11 and the main memory 12. The acquisition unit 110 acquires a commodity registration request from the POS terminal 2 via the communication interface 14. The commodity registration request includes the commodity identification information. The commodity registration request may include information regarding the number of commodities (including information regarding an increase or decrease of the number of commodities). The acquisition unit 110 acquires the information regarding the number of commodities together with the commodity identification information from the POS terminal 2 via the communication interface 14. Note that the acquisition unit 110 may acquire the commodity registration managing information from the POS terminal 2. In this case, the POS terminal 2 may output the commodity registration request to the server 1 and acquire the commodity information from the server 1. The POS terminal 2 may store the commodity registration managing information on the basis of the commodity information. In the following description, “acquire” may be regarded as “receive”.

The acquisition unit 110 acquires various notifications from the POS terminal 2 via the communication interface 14. Various notifications include a fraudulent operation notification regarding a fraudulent operation of the user of the POS terminal 2. The fraudulent operation includes an operation that does not correspond to variations in quantity of commodities in the cart 5. For example, the fraudulent operation includes a cancel operation, a minus operation of the quantity, no operation, and the like for an increase in quantity in the cart 5. In this case, it is conceivable that the user has forgotten an operation of registering a commodity, has performed a cancel operation by mistake, or has performed a minus operation of the quantity by mistake, with a commodity being put in the cart. The fraudulent operation includes registration operation, a plus operation of the quantity, no operation, and the like for a decrease in quantity in the cart 5. In this case, it is conceivable that the user has forgotten an operation of cancelling the commodity, has performed a registration operation by mistake, or has performed a plus operation of the quantity by mistake, with a commodity being taken out of the cart. The fraudulent operation notification is a notification indicating that a fraudulent point value of the fraudulent points exceeds a threshold set in advance. For example, if the threshold is five, the fraudulent operation notification is transmitted from the POS terminal 2 when the fraudulent point value exceeds five. When the fraudulent point value exceeds five, the fraudulent operation notification may be transmitted from the POS terminal 2 each time a fraudulent operation is detected from here forward. The fraudulent operation notification may be the same notification as the fraudulent operation notification displayed on a display device 26 of the POS terminal 2 or may be a different notification. In such manner, the threshold of the fraudulent points is provided, and when the fraudulent point value exceeds the threshold, the fraudulent operation notification is transmitted. This makes it possible to prevent a fraudulent operation notification due to erroneous detection from being transmitted and to efficiently monitor fraud prevention as compared to the case of transmitting a notification each time a fraudulent operation is detected.

The acquisition unit 110 may acquire a detection result from the POS terminal 2 via the communication interface 14.

The registration processing unit 111 performs the commodity registration processing on the basis of the commodity registration request acquired from the POS terminal 2. The commodity registration processing includes processing such as registration of a commodity, change of a commodity, and cancel of a commodity. The change of a commodity includes an increase or decrease in the quantity of commodities to be registered. When acquiring a commodity registration request from the POS terminal 2, the registration processing unit 111 acquires commodity information from the commodity master on the basis of the commodity identification) information included in the commodity registration request and records the commodity information in the commodity registration managing information. The commodity master is stored in, for example, the auxiliary storage device 13. The commodity master stores the commodity identification information and the commodity information of a commodity handled in the store in association with each other. The commodity information includes a commodity name, a price, and the like.

The output unit 112 outputs various notifications to the attendant terminal 4 via the communication interface 14. Further, the output unit 112 outputs the commodity registration managing information to the POS terminal 2 via the communication interface 14. In the following description, “output” can be regarded as “transmission”.

A configuration example of the POS terminal 2 will be described. The POS terminal 2 is an electronic device including a processor 21, a main memory 22, an auxiliary storage device 23, a communication interface 24, a connection interface 25, a display device 26, a speaker 27, an input device 28, and a camera 29. The units constituting the POS terminal 2 are connected to each other so as to be capable of inputting and outputting signals.

The processor 21 corresponds to the central portion of the POS terminal 2. The processor 21 is an element constituting the computer of the POS terminal 2. The processor 21 has a hardware configuration similar to that of the processor 11 described above. The processor 21 executes a program stored in advance in the main memory 22 or the auxiliary storage device 23 to execute various operations.

The main memory 2 corresponds to a main storage portion of the POS terminal 2. The main memory 22 is an element constituting the computer of the POS terminal 2. The main memory 22 has a hardware configuration similar to that of the main memory 12 described above. The main memory 22 stores a program.

The auxiliary storage device 23 corresponds to an auxiliary storage portion of the POS terminal 2. The auxiliary storage device 23 is an element constituting the computer of the POS terminal 2. The auxiliary storage device 23 has a hardware configuration similar to that of the auxiliary storage device 13 described above. The auxiliary storage device 23 stores the program described above.

The auxiliary storage device 23 stores commodity registration managing information of the POS terminal 2. The commodity registration managing information includes identification information or the like of the POS terminal 2. The identification information of the POS terminal 2 is unique identification information assigned to each POS terminal 2 so as to identify the individual POS terminals 2. The identification information of the POS terminal 2 includes an IP address or the like of the POS terminal 2. The commodity registration managing information may include user identification information of a user of the POS terminal 2. The user identification information is unique identification information assigned to each user so as to identify the individual users. The auxiliary storage device 23 can update the commodity registration managing information each time the commodity registration managing information is acquired from the server 1. The auxiliary storage device 23 stores information of time at which the commodity registration managing information is acquired from the server 1 in association with the commodity registration managing information.

The auxiliary storage device 23 stores a detection result of the POS terminal 2. The auxiliary storage device 23 can update the detection result each time the auxiliary storage device 23 acquires the detection result from the sensor 3. The auxiliary storage device 23 stores information of time at which the detection result is acquired from the sensor 3 in association with the detection result.

The auxiliary storage device 23 stores fraudulent point information of the POS terminal 2.

The communication interface 24 includes various interfaces that communicably connect the POS terminal 2 and another device to each other via a network according to a predetermined communication protocol. For example, the POS terminal 2 and an external device are communicably connected to each other via a network. The network may include a wireless network or may include a wired network. Further, the communication interface 24 receives a detection result from the sensor 3. The network includes, for example, a local area network (LAN), Bluetooth (registered trademark), Wi-Fi (registered trademark).

The connection interface 25 is an interface for wired connection between the POS terminal 2 and an external device. The external device includes the scanner 250.

The display device 26 is a device capable of displaying various screens under the control of the processor 21. For example, the display device 26 is a liquid crystal display, an electroluminescence (EL) display, or the like. The display device 26 is an example of a display unit.

The speaker 27 is a device capable of outputting sound under the control of the POS terminal 2. The speaker 27 is an example of a sound output device.

The input device 28 is a device capable of inputting data or an instruction to the POS terminal 2. The input device 28 may include a keyboard, a touch panel, and the like.

The camera 29 is a device capable of acquiring imaged data in an imaging range. The camera 29 can image a commodity in the cart 5, for example.

Note that a hardware configuration of the POS terminal 2 is not limited to the configuration described above. The POS terminal 2 can appropriately omit and change the constituent elements described above and add a new constituent element. The units implemented by the processor 21 described above will be described. The processor 21 implements a first acquisition unit 210, a second acquisition unit 211, a determination unit 212, a point processing unit 213, a display processing unit 214, and an output unit 215. The units implemented by the processor 21 can also be referred to as functions. The units implemented by the processor 21 can also be described as being implemented by a controller including the processor 21 and the main memory 22.

The first acquisition unit 210 acquires the detection result by the sensor 3 that detects an increase or decrease in number of commodities put in the cart 5. The first acquisition unit 210 acquires the detection result from the sensor 3 via the communication interface 24. The first acquisition unit 210 may acquire the detection result stored in the auxiliary storage device 23.

The second acquisition unit 211 acquires the commodity registration managing information from the server 1 via the communication interface 24. The second acquisition unit 211 may acquire the commodity registration managing information from the auxiliary storage device 23.

The determination unit 212 performs fraud determination processing. The determination unit 212 determines a fraudulent operation on the basis of the detection result and the commodity registration managing information. The determination unit 212 determines whether or not there is a record of a suitable commodity registration according to the detection result on the basis of the commodity registration managing information. If there is a record of a suitable commodity registration according to the detection result, the determination unit 212 determines that a suitable user operation has been performed. If there is no record of a suitable commodity registration according to the detection result, the determination unit 212 determines that an unsuitable user operation has been performed. The unsuitable user operation corresponds to a fraudulent operation.

By way of example, the determination unit 212 confirms the detection result periodically, and determines whether or not there is a record of a suitable commodity registration according to the detection result. In another example, the determination unit 212 determines whether or not there is a record of a suitable commodity registration according to the detection result on the basis of the fact that the first acquisition unit 210 has acquired the detection result. In other words, the determination unit 212 confirms the presence or absence of variations in quantity on the basis of the detection result. In each of the case where there are no variations in quantity and the case where there are variations in quantity, the determination unit 212 can determine whether the user operation is suitable or not with the detection result as a trigger. Note that the determination unit 212 may determine, on the basis of the fact that the commodity registration managing information has been updated, whether or not a detection result corresponding to that update has been acquired. In other words, the determination unit 212 determines whether or not a suitable detection result is detected on the basis of the fact that the commodity registration managing information has been updated, and if a suitable detection result is detected, determines that the user operation is suitable.

The point processing unit 213 performs point processing on the basis of the determination result by the determination unit 212. The point processing unit 213 calculates fraudulent points for a fraudulent operation on the basis of the fraudulent point information. The point processing unit 213 compares a fraudulent point value of the fraudulent points and a threshold with each other. The point processing unit 213 determines whether or not the fraudulent point value exceeds the threshold. For example, the point processing unit 213 may calculate fraudulent points on the basis of a timing at which an increase or decrease in quantity of commodities in the cart is detected by the sensor 3 and the commodity registration managing information is updated.

The display processing unit 214 causes the display device 26 to display various notifications. The display processing unit 214 causes the display device 26 to display various notifications on the basis of the fraudulent points. The display processing unit 214 causes the display device 26 to display a notification regarding the fraudulent operation on the basis of the fact that the point processing unit 213 determines that the fraudulent point value of the fraudulent points exceeds the threshold. Note that the display processing unit 214 may cause the display device 26 to display a notification regarding the fraudulent operation on the basis of the fact that the fraudulent operation has been detected.

The output unit 215 outputs various requests via the communication interface 24. The output unit 215 outputs various notifications to the server 1 via the communication interface 24. For example, the output unit 215 outputs various notifications to the server 1 on the basis of the fraudulent points. If the fraudulent point value of the fraudulent points exceeds the threshold, the output unit 215 outputs a notification regarding the fraudulent operation to the server 1 on the basis of the determination result by the point processing unit 213. The output unit 215 may output the detection result to the server 1 via the communication interface 24. Further, the output unit 215 may output a notification indicating a fraudulent operation to the server 1 each time a fraudulent operation or a correction operation is detected.

### Operation Example

The processing by the information processing system 100 will be described. In the following description in which the server 1 is the subject, the server 1 may be regarded as the processor 11. Similarly, in the description in which the POS terminal 2 is the subject, the POS terminal 2 may be regarded as the processor 21. Note that the processing procedures to be described below are merely examples, and each processing may be changed as much as possible. Further, in the processing procedures to be described below, omission, replacement, and addition of steps can be appropriately performed according to the embodiment. In the following processing, it is assumed that the user of the POS terminal 2 purchases things at a store A.

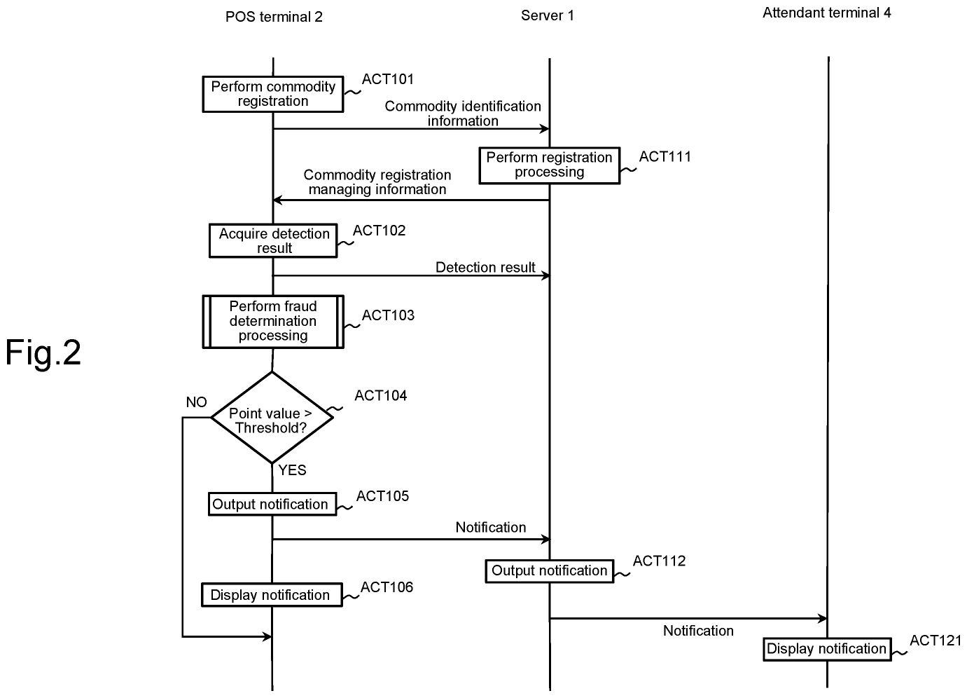

FIG. 2 is a sequence diagram illustrating a procedure of information processing by the information processing system 100 according to the embodiment.

The POS terminal 2 performs commodity registration processing on the basis of a user operation (ACT101). In other words, the output unit 215 of the POS terminal 2 outputs a commodity registration request including commodity identification information to the server 1.

The registration processing unit 111 of the server 1 stores commodity registration managing information in the auxiliary storage device 13 on the basis of the commodity registration request (ACT111). The output unit 112 of the server 1 outputs the commodity registration managing information to the POS terminal 2. The POS terminal 2 stores the commodity registration managing information in the auxiliary storage device 23.

The sensor 3 outputs a detection result of variations in quantity of commodities in the cart to the POS terminal 2 at predetermined time intervals. The first acquisition unit 210 of the POS terminal 2 acquires the detection result from the sensor 3 (ACT102). Note that the sensor 3 may output the detection result to the server 1. In this case, the acquisition unit 110 of the server 1 acquires the detection result.

The determination unit 212 of the POS terminal 2 performs fraud determination processing (ACT103). The POS terminal 2 may determine whether or not a user operation is suitable with the detection result as a trigger.

The point processing unit 213 of the POS terminal 2 performs point processing on the basis of a determination result by the determination unit 212 (ACT104). The point processing unit 213 of the POS terminal 2 determines whether or not a point value of the fraudulent points exceeds a threshold. The point processing unit 213 may determine whether or not an accumulated point value for the POS terminal 2 exceeds the threshold. The point processing unit 213 may determine whether or not the point value of the fraudulent points for the POS terminal 2 by one-time point processing exceeds the threshold.

If the point processing unit 213 determines that the point value of the fraudulent points exceeds the threshold (ACT104: YES), the processing of the POS terminal 2 proceeds from ACT104 to ACT105. If the point processing unit 213 determines that the point value of the fraudulent points does not exceed the threshold (ACT104: NO), the processing of the POS terminal 2 is terminated.

The output unit 215 of the POS terminal 2 outputs a notification regarding the fraudulent operation to the server 1 (ACT105). The notification regarding the fraudulent operation is text information, e.g., “A fraudulent operation has been detected.” The output unit 215 of the POS terminal 2 may output a notification regarding the fraudulent operation as a sound or a moving image.

The acquisition unit 110 of the server 1 acquires the notification regarding the fraudulent operation. The output unit 112 of the server 1 outputs the notification regarding the fraudulent operation to the attendant terminal 4 (ACT112). The output unit 112 of the server 1 may output the notification regarding the fraudulent operation as a sound or a moving image.

The attendant terminal 4 displays a notification image on a display device on the basis of the notification regarding the fraudulent operation (ACT121). The attendant terminal 4 may output the notification regarding the fraudulent operation as a sound or a moving image. The user of the attendant terminal 4 confirms the notification and confirms the cart 5 of the corresponding POS terminal 2 as necessary.

The display processing unit 214 of the POS terminal 2 displays a notification image on the display device 26 on the basis of the notification regarding the fraudulent operation. The POS terminal 2 may output the notification regarding the fraudulent operation as a sound or a moving image.

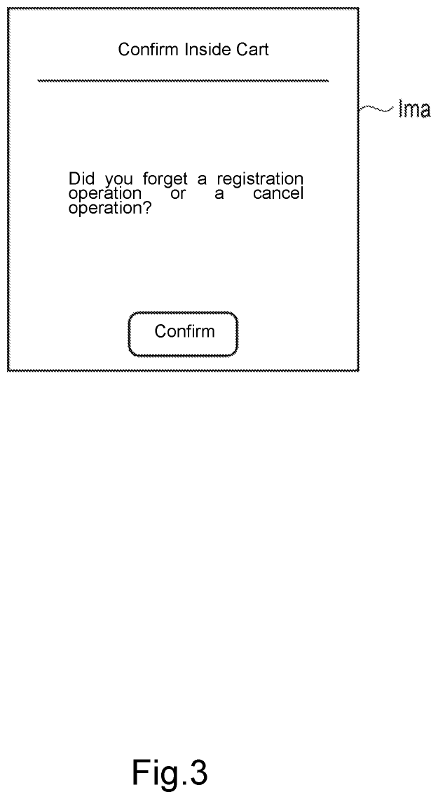

The notification regarding the fraudulent operation displayed on the display device 26 of the POS terminal 2 will be described. FIG. 3 is a schematic diagram showing an example of the notification image displayed in the POS terminal 2 according to the embodiment. FIG. 3 shows a notification image Ima that is displayed on the display device 26 of the POS terminal 2 in the commodity registration. The notification image Ima shows that a fraudulent operation has been performed. The notification image Ima is displayed on the display device 26 when the point value of the fraudulent points exceeds a threshold. The notification image Ima includes a message that prompts the user to perform a commodity registering operation, a cancel operation, or the like. The notification image Ima includes text information, e.g., “Did you forget a registration operation or a cancel operation?” The notification image Ima may include a “confirmation” button.

The user of the POS terminal 2 confirms the notification image Ima and performs a registration operation, a cancel operation, or the like. The display processing unit 214 of the POS terminal 2 may hide the notification image Ima after the elapse of a certain period of time or may hide the notification image Ima on the basis of an operation of selecting the “confirmation” button by the user.

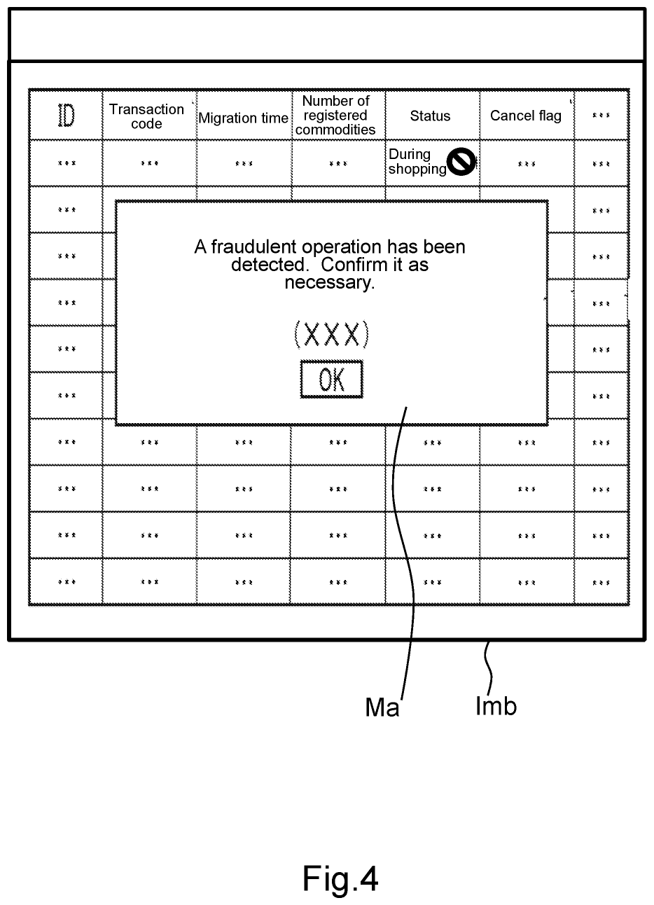

The notification regarding the fraudulent operation displayed on the attendant terminal 4 will be described. FIG. 4 is a schematic diagram showing an example of the notification image displayed in the attendant terminal 4 according to the embodiment. FIG. 4 shows a status confirmation image Imb displayed in the attendant terminal 4. The status confirmation image Imb is an image for confirming a status of one or more POS terminals 2. The status confirmation image Imb includes a notification Ma.

The status confirmation image Imb includes a terminal ID, a transaction code, a migration time, the number of registered commodities, a transaction status, a cancel flag, and the like. The terminal ID indicates the identification information of the POS terminal 2. The transaction code indicates identification information with which commodity registration managing information can be identified. The migration time indicates a period of time since the start of use of the POS terminal 2 by the user. The number of registered commodities indicates the quantity of commodities registered by the user. The transaction status indicates a status of the POS terminal 2, such as “entry to store”, “during shopping”, “during checkout”, and “leaving from store”. The cancel flag indicates that the user has operated a cancel button for cancelling the commodity registration after the user starts commodity registration.

The notification Ma includes text information, e.g., “A fraudulent operation has been detected. Confirm it as necessary.” The notification Ma may include an “OK” button. The notification Ma may include an identification number or the like of the POS terminal 2. The status confirmation image Imb may include an icon indicating an error as the notification regarding the fraudulent operation. For example, the attendant terminal 4 may display an icon indicating an error in a transaction status column.

The user of the attendant terminal 4 confirms the notification Ma and confirms the cart 5 of the corresponding POS terminal 2 as necessary.

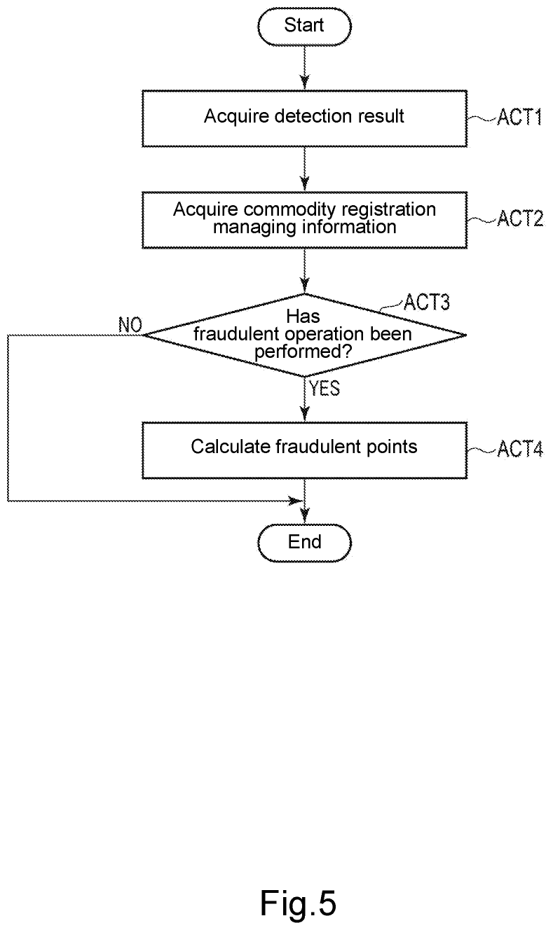

The fraud determination processing will be described. FIG. 5 is a flowchart showing an example of the information processing by the processor 21 of the POS terminal 2 according to the embodiment. FIG. 5 shows the fraud determination processing of ACT103 in the sequence diagram shown in FIG. 2. In FIG. 5, it is assumed that the fraud determination processing is performed on the basis of the fact that the first acquisition unit 210 of the processor 21 has acquired a detection result of variations in quantity of the commodities put in the cart 5. Specifically, the first acquisition unit 210 acquires a detection result periodically, and determines whether or not there is an unsuitable user operation with the acquisition of the detection result as a trigger. The POS terminal 2 stores the detection result in the auxiliary storage device 23.

In ACT1, the first acquisition unit 210 of the processor 21 acquires a detection result of variations in quantity of commodities in the cart. For example, the first acquisition unit 210 acquires a detection result from the auxiliary storage device 23.

In ACT2, the second acquisition unit 211 of the processor 21 acquires commodity registration managing information from the auxiliary storage device 23.

In ACT3, the determination unit 212 of the processor 21 determines a fraudulent operation on the basis of the detection result and the commodity registration managing information. For example, the determination unit 212 determines whether or not there is a record of a suitable commodity registration according to the detection result on the basis of the commodity registration managing information.

For example, the case where the detection result acquired by the first acquisition unit 210 of the processor 21 indicates “no variations in quantity” will be described. In this example, if the commodity registration managing information indicates that the user has performed a plus operation or a minus operation, the determination unit 212 of the processor 21 determines that a suitable user operation according to the detection result has not been performed. If the commodity registration managing information indicates that the user has performed no operation, the determination unit 212 determines that a suitable user operation according to the detection result has been performed. The determination that a suitable user operation has not been performed corresponds to a determination that a fraudulent operation has been performed.

The case where the detection result acquired by the first acquisition unit 210 of the processor 21 indicates “an increase in quantity” will be described. In this example, if the commodity registration managing information indicates that the user has performed a plus operation, the determination unit 212 of the processor 21 determines that a suitable user operation according to the detection result has been performed. If the commodity registration managing information indicates that the user has performed a minus operation or the user has performed no operation, the determination unit 212 determines that a suitable user operation according to the detection result has not been performed.

The case where the detection result acquired by the first acquisition unit 210 of the processor 21 indicates “a decrease in quantity” will be described. In this example, if the commodity registration managing information indicates that the user has performed a minus operation, the determination unit 212 of the processor 21 determines that a suitable user operation according to the detection result has been performed. If the commodity registration managing information indicates that the user has performed a plus operation or the user has performed no operation, the determination unit 212 determines that a suitable user operation according to the detection result has not been performed.

In ACT3, if the determination unit 212 of the processor 21 determines that a fraudulent operation has been performed (ACT3: YES), the processing of the processor 21 proceeds from ACT3 to ACT4. If the determination unit 212 determines that a fraudulent operation has not been performed (ACT3: NO), the processing of the processor 21 is terminated.

In ACT4, the point processing unit 213 of the processor 21 calculates fraudulent points on the basis of the determination result by the determination unit 212. For example, the point processing unit 213 calculates fraudulent points for the fraudulent operation determined by the determination unit 212 on the basis of the fraudulent point information. In this example, it is assumed that the point processing unit 213 calculates fraudulent points on the basis of a difference between a timing at which an increase or decrease in quantity of commodities in the cart is detected and a timing at which the commodity registration managing information is updated. The point processing unit 213 compares time information indicating a detection date and time included in the detection result and time information that is included in the commodity registration managing information and indicates an update date and time of the commodity registration managing information. The point processing unit 213 calculates fraudulent points on the basis of the comparison result. For example, the following case will be described: if a time difference between the detection date and time and the update date and time of the commodity registration managing information exceeds a predetermined period of time, in the fraudulent point information, “two points” of fraudulent point are added, and if the time difference is equal to or smaller than the predetermined period of time, “one point” of fraudulent point is added. If the time difference based on the comparison result exceeds the predetermined period of time, the point processing unit 213 adds “two points” of fraudulent point. If the time difference based on the comparison result is equal to or smaller than the predetermined period of time, the point processing unit 213 adds “one point” of fraudulent point. Note that the point processing unit 213 can calculate fraudulent points on the basis of a point value indicated by the fraudulent point information.

Note that the POS terminal 2 may perform the fraud determination processing on the basis of the fact that the commodity registration managing information has been updated. Specifically, the commodity registration managing information may be acquired from the server 1 to determine whether or not an unsuitable user operation has been performed with the acquisition of the commodity registration managing information as a trigger. According to this example, it is possible to detect that the user forgets to put or take out a commodity, which cannot be detected in the case where the fraud determination processing is performed on the basis of the fact that the detection result of variations in quantity has been acquired.

### Modifications

The processor 11 of the server 1 may implement the first acquisition unit 210, the second acquisition unit 211, the determination unit 212, and the point processing unit 213 of the POS terminal 2. In this case, the server 1 is an example of an information processing apparatus.

In this example, the output unit 112 of the server 1 can output a notification to the user of the POS terminal 2 when the point value of the fraudulent points calculated by the server 1 exceeds the threshold. The user of the POS terminal 2 can receive the notification on the basis of the fraudulent points. Thus, the server 1 can prevent a notification due to an erroneous detection of a fraudulent operation from being transmitted. As described above, the server 1 can reduce the number of notifications due to an erroneous detection of a fraudulent operation by transmitting a notification on the basis of the fraudulent points.

### Effects

The POS terminal 2 according to the embodiment acquires the detection result detected by the sensor that detects an increase or decrease in number of commodities put in the cart, and acquires the commodity registration managing information. The POS terminal 2 determines a fraudulent operation on the basis of the detection result and the commodity registration managing information. The POS terminal 2 can calculate fraudulent points on the basis of the determination result. For example, when the quantity of commodities in the cart varies, the POS terminal 2 determines whether or not the user of the POS terminal 2 has performed a plus operation or a minus operation. If it is determined that a fraudulent operation has been performed, the POS terminal 2 calculates fraudulent points. The POS terminal 2 can perform fraudulent operation processing on the basis of the fraudulent points, not on the basis of the fact that the fraudulent operation has been performed. Thus, the POS terminal 2 can prevent a notification due to an erroneous detection of a fraudulent operation from being transmitted. In such a manner, the POS terminal 2 can reduce the number of notifications due to an erroneous detection of a fraudulent operation by performing the fraudulent operation processing on the basis of the fraudulent points.

Further, the POS terminal 2 can display the notification on the display device on the basis of the fraudulent points. The POS terminal 2 can display the notification on the basis of the fraudulent points, instead of displaying a notification each time it is detected that a fraudulent operation has been performed. Thus, the POS terminal 2 can prevent a notification due to an erroneous detection of a fraudulent operation from being transmitted. In such a manner, the POS terminal 2 can reduce the number of notifications due to an erroneous detection of a fraudulent operation by transmitting a notification on the basis of the fraudulent points.

The POS terminal 2 according to the embodiment can determine whether or not the point value of the fraudulent points exceeds the threshold and can display a notification on the display device on the basis of the fact that the point value of the fraudulent points exceeds the threshold. Thus, the POS terminal 2 can transmit a notification only when the point value of the fraudulent points exceeds the threshold. This makes it possible for the POS terminal 2 to reduce the number of notifications due to an erroneous detection of a fraudulent operation by transmitting a notification on the basis of the fraudulent points.

The POS terminal 2 according to the embodiment can output a notification on the basis of accumulated points in a certain period of time. The POS terminal 2 accumulates fraudulent points in the certain period of time and outputs a notification on the basis of the accumulated points. Thus, it is possible to further prevent a notification due to an erroneous detection of a fraudulent operation from being transmitted. This makes it possible for the POS terminal 2 to reduce the number of notifications due to an erroneous detection of a fraudulent operation.

The POS terminal 2 according to the embodiment calculates the fraudulent points on the basis of the timings of the detection by the sensor 3 and the update of the commodity registration managing information. Thus, the POS terminal 2 can increase or decrease the fraudulent points according to a timing at which the fraudulent operation is performed. Thus, the POS terminal 2 can reduce addition of fraudulent points due to an erroneous detection of a fraudulent operation. In such a manner, the POS terminal 2 can reduce the number of notifications due to an erroneous detection of a fraudulent operation.

The POS terminal 2 according to the embodiment outputs a notification to the server 1 on the basis of the fraudulent points. The POS terminal 2 outputs a notification to the attendant terminal 4 via the server 1 on the basis of the fraudulent points to transmit a notification regarding the fraudulent operation to the user of the attendant terminal 4. The server 1 does not display a notification each time it is detected that the fraudulent operation has been performed, but outputs a notification to the attendant terminal 4 on the basis of the fraudulent points. The user of the attendant terminal 4 can tell the user of the POS terminal 2 to avoid cheating on the basis of the notification. This makes it possible for the POS terminal 2 to reduce the number of notifications due to an erroneous detection of a fraudulent operation to the attendant.

### OTHER EMBODIMENTS

The information processing apparatus may be implemented by a single electronic device such as the server 1 or the POS terminal 2 or may be implemented by a plurality of electronic devices in which functions are dispersed.

The embodiment described above may be applied to not only an apparatus but also a method executed by the apparatus. The embodiment described above may be applied to a program that can cause a computer of the apparatus to execute functions. The embodiment described above may be applied to a recording medium that stores a program.

The program may be delivered in a state of being stored in the electronic device or may be delivered in a state of not being stored in the electronic device. In the latter case, the program may be delivered via a network or may be delivered in a state of being recorded on a recording medium. The recording medium is a non-transitory tangible medium. The recording medium is a computer-readable medium. The recording medium only needs to be a medium that can store a program and is computer-readable, such as a CD-ROM or a memory card, regardless of the form of the medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus that receives, when a user puts a commodity to be purchased in a cart in which and from which a commodity can be put and taken out, a user operation for registration processing of the commodity to be purchased and performs the registration processing of the commodity to be purchased, the information processing apparatus comprising:
a communication interface that receives a detection result of a sensor included in the cart, the sensor detecting an increase or a decrease in number of commodities put in the cart;
a storage device that stores the detection result of the sensor and commodity registration managing information including commodity information based on the registration processing of the commodity to be purchased;
a memory that stores a program; and
a processor that executes the program to be configured to
acquire the detection result of the sensor via the communication interface and cause the storage device to store the detection result,
acquire the commodity registration managing information and cause the storage device to store the commodity registration managing information each time the registration processing of the commodity to be purchased is performed,
determine a user's fraudulent operation regarding putting a commodity in and taking a commodity out of the cart on a basis of the detection result and the commodity registration managing information, and
calculate fraudulent points on a basis of a result of the determination.

2. The information processing apparatus according to claim 1, further comprising
a display device that displays a notification to the user, wherein
the processor causes the display device to display the notification on a basis of the calculated fraudulent points.

3. The information processing apparatus according to claim 2, wherein
the processor
determines whether or not a point value of the calculated fraudulent points exceeds a threshold, and
causes the display device to display the notification if it is determined that the point value of the fraudulent points exceeds the threshold.

4. The information processing apparatus according to claim 1, wherein
the processor obtains an accumulated point value in a certain period of time of the fraudulent points.

5. The information processing apparatus according to claim 4, further comprising
a display device that displays a notification to the user, wherein
the processor causes the display device to display the notification on a basis of the obtained accumulated point value of the fraudulent points.

6. The information processing apparatus according to claim 5, wherein
the processor
determines whether or not the obtained accumulated point value of the fraudulent points exceeds a threshold, and
causes the display device to display the notification if it is determined that the obtained accumulated point value of the fraudulent points exceeds the threshold.

7. The information processing apparatus according to claim 1, wherein
the processor calculates the fraudulent points on a basis of timings of detection by the sensor and update of the commodity registration managing information.

8. The information processing apparatus according to claim 7, further comprising
a display device that displays a notification to the user, wherein
the processor
calculates the fraudulent points on a basis of the timings of the detection by the sensor and the update of the commodity registration managing information, and
causes the display device to display the notification on a basis of the calculated fraudulent points.

9. The information processing apparatus according to claim 1, wherein
the processor outputs a notification to the user on a basis of the calculated fraudulent points.

10. An information processing method for an information processing apparatus that receives, when a user puts a commodity to be purchased in a cart in which and from which a commodity can be put and taken out, a user operation for registration processing of the commodity to be purchased and performs the registration processing of the commodity to be purchased, the information processing method comprising:
acquiring a detection result of a sensor that detects an increase or a decrease in number of commodities put in the cart via a communication interface and storing the detection result in a storage device;
acquiring commodity registration managing information including commodity information based on the registration processing of the commodity to be purchased and storing the commodity registration managing information in the storage device each time the registration processing of the commodity to be purchased is performed;
determining a user's fraudulent operation regarding putting a commodity in and taking a commodity out of the cart on a basis of the detection result and the commodity registration managing information; and
calculating fraudulent points on a basis of a result of the determination.
